(19) United States
(12) Patent Application Publication
(10) Pub. No.: US 2024/0218247 A1
(43) Pub. Date: Jul. 4, 2024

(54) I-III-VI BASED QUANTUM DOTS AND FABRICATION METHOD THEREOF

(71) Applicant: Hongik University Industry-Academia Cooperation Foundation, Seoul (KR)

(72) Inventors: Hee-Sun YANG, Seoul (KR); Yuri KIM, Gimpo-si (KR); Yubeen KONG, Incheon (KR)

(21) Appl. No.: 18/452,161

(22) Filed: Aug. 18, 2023

(30) Foreign Application Priority Data
Jan. 4, 2023 (KR) 10-2023-0001462
Jun. 28, 2023 (KR) 10-2023-0083809

(51) Int. Cl. C09K 11/88; C09K 11/02

(52) U.S. Cl. CPC C09K 11/881; C09K 11/025; B82Y 20/00

(57) ABSTRACT

Quantum dots are proposed. Quantum dots include a multicomponent quantum dot core including four or more elements selected from a combination of Group 11-Group 13-Group 16. The quantum dots may emit band-edge peak wavelength from a red region (590 nm) to an infrared region (700 nm or more).

### CROSS-REFERENCE TO RELATED APPLICATION

The present application claims priority to Korean Patent Application No. 10-2023-0001462 filed on Jan. 4, 2023, and Korean Patent Application No. 10-2023-0083809 filed on Jun. 28, 2023, in the Republic of Korea, the disclosures of each of which are incorporated herein by reference in their entireties.

### BACKGROUND

### Technical Field

The present disclosure relates to quantum dots of non Cd composition and a method for fabricating the same, and more particularly, to I-III-VI based quantum dots and a method for fabricating the same.

### Description of Related Technology

Quantum dots are semiconductor particles a few tens of nm or less in size, and as opposed to bulk materials, they exhibit various characteristics depending on the size and composition of the particles and have optical and electrical properties that the commonly used semiconducting materials do not have. The quantum dots have better optical properties such as narrower full width at half maximum and higher emission intensity than organic material based fluorescent dyes, and since they are made of inorganic based material, they have a stability advantage. Due to these characteristics, quantum dots are attracting significant attention as materials of color filters for displays, emission diodes (LEDs), biosensors, lasers and solar cells.

### SUMMARY

One aspect is I-III-VI based quantum dots that emit light in various wavelength bands and have narrow full width at half maximum and high absorption coefficient and a method for fabricating the same.

Another aspect is quantum dots including a multicomponent quantum dot core including four or more elements selected from a combination of Group 11-Group 13-Group 16, wherein the quantum dots emit band-edge peak wavelength from a red region (590 nm) to an infrared region (700 nm or more).

The quantum dots may further include Group 17 element attached to a surface of the quantum dot core.

In some embodiments, in the quantum dot core, the Group 11 element is Ag, the Group 13 element is In or Ga, and the Group 16 element is S or Se.

The quantum dot core may include one Group 11 element, one or two Group 13 elements, and two Group 16 elements.

In some embodiments, the quantum dot core may include Ag, In, Ga, S and Se.

In some embodiments, the quantum dot core may include Ag, In, S and Se.

The quantum dot core may include In and Ga, and the Ga/In in the quantum dot core may be 0 to 4.

The quantum dot core may include S and Se, and the Se/S in the quantum dot core may be 0.01 to 1.0.

The quantum dots may further include ligands on the surface of the quantum dot core.

The ligands may be at least one of thiols, amines, phosphines or metal salts.

Specifically, the ligands may be at least one of 1-butanethiol, 1-hexanethiol, 1-octanethiol (OTT), 1-undecanethiol, decanethiol, 1-dodecanethiol (DDT), 1-hexadecanethiol, 1-octadecanethiol, amylamine, butylamine. hexylamine, heptylamine, octylamine, nonylamine, decylamine, didecylamine, tetradecylamine, hexadecylamine, octadecylamine, oleylamine (OLA), trihexylamine, trioctylamine (TOA), tridodecylamine, tributylphosphine oxide, tributylphosphine, trioctylphosphine oxide (TOPO), trioctylphosphine (TOP), ZnF₂, ZnCl₂, ZnBr₂, ZnI₂, GaF₃, GaCl₃, GaBr₃, GaI₃, AlF₃, AlCl₃, AlBr₃ or AlI₃.

In some embodiments, the quantum dot core includes Ag, In, Ga, S and Se, or includes Ag, In, S and Se, and the Group 17 element is I attached in an atomic or ionic form.

The quantum dots may further include a shell on the quantum dot core, wherein the shell includes at least one of Group 12 and 13 elements and at least one of Group 16 elements.

The shell may have a composition including at least one including at least Ga among Al, Ga and In and at least one including at least S among S and Se.

The quantum dot core may exhibit defect state emission, and the shell may realize band-edge peak wavelength.

The quantum dot core may be 3.5 nm to 8 nm in diameter.

The quantum dots according to the present disclosure may have a ratio of band-edge emission intensity and defect state emission intensity of 2:1 or less on the full PL spectrum of the quantum dot core.

Under 450 nm blue light excitation, the quantum dot core may exhibit a molar absorption coefficient of 1.8×10⁶ M⁻¹ cm⁻¹ or more.

The quantum dots according to the present disclosure may be free of defect states by the Group 17 element and/or the shell.

The quantum dots further including the shell may have emission intensity that is at least four times higher than the quantum dot core.

The photoluminescent quantum yield (PL QY) of the quantum dots further including the shell may be 65% or more in the visible light region (400 nm to 700 nm).

The full width at half maximum of the quantum dots further including the shell may be 55 nm or less in the visible light region.

The photoluminescent quantum yield of the quantum dots further including the shell may be 30% or more in the infrared region (700 nm or more).

The full width at half maximum of the quantum dots further including the shell may be 100 nm or less in the infrared region.

Under 450 nm blue light excitation, the quantum dots further including the shell may exhibit the molar absorption coefficient of 7.1×10⁵ M⁻¹ cm⁻¹ or more.

A method for fabricating quantum dots according to the present disclosure includes synthesizing a quantum dot core using a halide based metal salt precursor, wherein the quantum dot core is a multicomponent quantum dot core including four or more elements selected from a combination of Group 11-Group 13-Group 16, the quantum dots include Group 17 element attached to a surface of the quantum dot core, and the Group 17 element is supplied from the halide based metal salt precursor.

The halide based metal salt precursor may include a Group 11 precursor and a Group 13 precursor, and the Group 17 element may be supplied from the Group 11 precursor and the Group 13 precursor.

The Group 11 precursor and the Group 13 precursor may be at least one of AuF, AuCl, AuBr, AuI, CuF, CuCl, CuBr, CuI, AgF, AgCl, AgBr, AgI, InF₃, InCl₃, InBr₃, InI₃, GaF₃, GaCl₃, GaBr₃ or GaI₃.

In addition to the halide based metal salt precursor, a Group 16 precursor may be further used, and Group 16 element of the Group 16 precursor may be fed as it is dissolved in a solvent.

The solvent may be at least one of 1-octadecene (ODE), oleylamine (OLA), oleic acid (OA), dodecylamine, trioctylamine (TOA), trioctylphosphine (TOP), 1-butanethiol, 1-hexanethiol, 1-octanethiol (OTT), 1-undecanethiol, decanethiol, 1-dodecanethiol (DDT), 1-hexadecanethiol, or 1-octadecanethiol.

A reaction temperature at the synthesis of the quantum dot core may be 180° C. to 300° C.

The method for fabricating quantum dots according to the present disclosure may further include forming a shell on the quantum dot core, wherein the shell includes at least one of Group 12 and 13 elements and at least one of Group 16 elements.

The method may further include, after synthesizing the quantum dot core or forming the shell, feeding a ligand material to protect the surface of the quantum dots.

In this instance, the ligand may be at least one of tributylphosphine oxide, tributylphosphine, trioctylphosphine oxide (TOPO) or trioctylphosphine (TOP).

The method may further include purifying the quantum dot core before forming the shell, and the purification may include causing the quantum dot core to settle down using a polar solvent to remove by-products and unreacted products except the quantum dot core.

According to the present disclosure, it may be possible to fabricate I-III-VI based quantum dots having quantum dot core including Ag. In, Ga. S and Se (hereinafter, AIGSSe quantum dots) or quantum dot core including Ag. In, S and Se (hereinafter, AISSe quantum dots) for increasing the photoluminescent quantum yield and reducing the defect state emission by surface control.

The high efficiency I-III-VI based quantum dots fabricated according to the present disclosure may be synthesized as visible light emitting quantum dots, especially, red light emitting quantum dots with higher absorbance than InP quantum dots. It may be possible to obtain quantum dots that emit from the red region (590 nm) to the infrared region (700 nm or more) by adjusting In/Ga in the quantum dot core when the quantum dot core includes In and Ga, and by adjust Se/S in the quantum dot core when the quantum dot core includes S and Se.

The quantum dots synthesized using halide based metal salt precursors according to the present disclosure include halogen on the surface and thus may be fabricated as quantum dots with enhanced band-edge emission and reduced defect state emission.

According to the present disclosure, it may be possible to form the multicomponent quantum dot core including four or more elements selected from a combination of Group 11-Group 13-Group 16 exhibiting a remarkably low level of defect state emission and fabricate quantum dots with high color purity after the core/shell step.

According to the present disclosure, it may be possible to fabricate red quantum dots with high blue absorbance.

According to the present disclosure, it may be possible to obtain quantum dots with dominant band-edge emission for use as display materials.

### DESCRIPTION OF THE DRAWINGS

FIG. 1 is a diagram of quantum dots according to an embodiment of the present disclosure.

FIG. 2 is a flowchart of a method for fabricating quantum dots according to an embodiment of the present disclosure.

FIG. 3 is a flowchart of a method for fabricating AIGSSe/GS core/shell quantum dots according to an experimental example of the present disclosure.

FIG. 4 shows (a) core and (b) core/shell emission spectrum of AIGSSe/GS quantum dots synthesized at varying reaction temperatures (260° C., 280° C., 300° C.).

FIG. 5 is a transmission electron microscopy (TEM) image of AIGSSe quantum dot core synthesized at varying reaction temperatures; (a) is a TEM image at 260° C., (b) is a TEM image at 280° C., and (c) is a TEM image at 300° C.

FIG. 6 shows (a) core and (b) core/shell absorbance spectrum of InP quantum dots according to comparative example and AIGSSe/GS quantum dots according to an experimental example of the present disclosure.

FIG. 7 shows (a) core and (b) core/shell emission spectrum of AIGSSe/GS quantum dots synthesized with varying In:Ga.

FIG. 8 shows (a) core and (b) core/shell emission spectrum of AIGSSe/GS quantum dots synthesized with varying Se/S.

FIG. 9 shows (a) core and (b) core/shell emission spectrum of AISSe/GS quantum dots synthesized at varying reaction temperatures (180° C., 200° C., 220° C.).

FIG. 10 is a TEM image of AISSe quantum dot cores synthesized at varying reaction temperatures; (a) is a TEM image at 180° C., (b) is a TEM image at 200° C., and (c) is a TEM image at 220° C.

FIG. 11 is a TEM image of AISSe/GS quantum dots including AISSe quantum dot core synthesized in a specific condition (200° C., Se/S 0.15) and GS shell.

FIG. 12 shows (a) core and (b) core/shell emission spectrum of AISSe/GS quantum dots synthesized with varying Se/S.

### DETAILED DESCRIPTION

Typically, compound semiconductor compositions made up of Group II-VI elements on the periodic table have been studied, but high efficiency quantum dots include hazardous materials to humans such as Cd or Pb, which makes it difficult to use in industrial applications. Compound semiconductors made up of Group III-V elements typically include InP quantum dots, and InP quantum dots have the photoluminescent quantum yield of 95% or more and the narrow full width at half maximum of 40 nm or less, and thus are used in a wide range of industrial applications. In display applications, InP quantum dots are used for a photoconversion layer (a color filter for display) on a blue LED. The blue excitation light and re-emission of red and green light produces color, and when quantum dots are small in size, the quantum dots have difficulty in sufficient light absorption. The core diameter of the green InP quantum dots is about 2 to 2.5 nm, while the core diameter of the red InP quantum dots is 3 to 3.5 nm, and the difference in absorbance between them is a few fold. Accordingly, to have the equal absorbance, the green InP quantum dots need the photoconversion layer having the concentration that is a few times higher than the red InP quantum dots. Red InP quantum dots also have low blue light conversion efficiency, so research of alternative materials is needed.

I-III-VI based quantum dots typically include CuInS₂ (shortened to CIS) and AgInS₂ (shortened to AIS), and typically include Group III elements and further include Ga. Usually, the emission from defect state, not band-edge, is seen, and the broad full width at half maximum of 100 nm or more is observed. By this reason, they are difficult to use as display materials, and have been used in solar cell or infrared device applications. To use I-III-VI based quantum dots as display materials, they need to have the full width at half maximum of 50 nm or less, dominant band-edge emission and high photoluminescent quantum yield.

Recently, it is known that AIS based quantum dots with band-edge emission and narrow full width at half maximum have been synthesized, but it is difficult to use as red light emitting display materials, in general, requiring the wavelength of 610 to 630 nm with the center wavelength of about 580±5 nm, and accordingly, there is a need for material improvement.

The accompanying drawings illustrate an exemplary embodiment of the present disclosure, and together with the foregoing detailed description, serve to provide a further understanding of the technical aspects of the present disclosure, and thus the present disclosure should not be construed as being limited to the accompanying drawings.

Quantum dots according to the present disclosure and a method for fabricating the same will be described in detail with reference to the accompanying drawings. The accompanying drawings are provided by way of illustration to convey the technical aspects of the present disclosure fully and completely. Accordingly, the present disclosure is not limited to the accompanying drawings and may be embodied in any other form. It is obvious that the technical and scientific terms as used herein have the meaning of the terms commonly understood by those skilled in the art unless defined otherwise. Additionally, where there is a certain detailed description of known functions and elements that may unnecessarily obscure the subject matter of the present disclosure in the following description and the accompanying drawings, the detailed description is omitted.

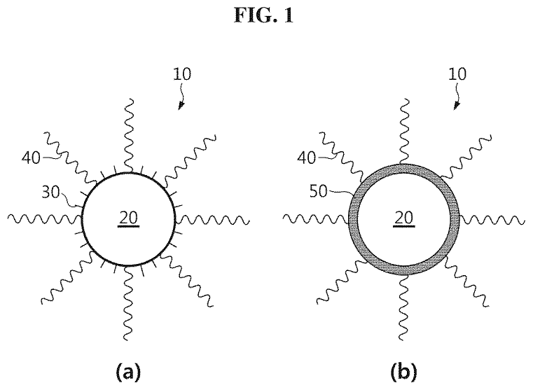

FIG. 1 is a diagram of quantum dots according to an embodiment of the present disclosure.

(a) of FIG. 1 is a diagram of quantum dot core, and (b) of FIG. 1 is a diagram of core/shell quantum dot.

Referring to (a) of FIG. 1, the quantum dots 10 according to an embodiment of the present disclosure include the multicomponent quantum dot core 20 including four or more elements selected from a combination of Group 11-Group 13-Group 16. The quantum dots 10 emit band-edge peak wavelength from the red region (590 nm) to the infrared region (700 nm or more). In particular, the quantum dot core 20 may emit from defect state, and as shown in (b) of FIG. 1, the quantum dots 10 further include the shell 50, the shell 50 may realize band-edge peak wavelength to allow the quantum dots 10 to emit from the red region (590 nm) to the infrared region (700 nm or more).

The quantum dots 10 may further include Group 17 element 30 attached to the surface of the quantum dot core 20. The quantum dots 10 are surface-controlled by the Group 17 element 30 to increase the photoluminescent quantum yield and reduce the defect state emission. The quantum dot core 20 may be fabricated by a solution process. In particular, the quantum dot core 20 may be synthesized using a halide based metal salt precursor, and the Group 17 element 30 is supplied from the halide based metal salt precursor. For example, the precursor for fabricating the quantum dot core 20 may be at least one of GaI₃, GaBr₃ or GaCl₃.

The quantum dots 10 may further include ligands 40 on the surface of the quantum dot core 20. The ligands 40 may be at least one of thiols, amines, phosphines or metal salts. For example, the ligands 40 may be at least one of 1-butanethiol, 1-hexanethiol, 1-octanethiol (OTT), 1-undecanethiol, decanethiol, 1-dodecanethiol (DDT), 1-hexadecanethiol, 1-octadecanethiol, amylamine, butylamine, hexylamine, heptylamine, octylamine, nonylamine, decylamine, didecylamine, tetradecylamine, hexadecylamine, octadecylamine, oleylamine (OLA), trihexylamine, trioctylamine (TOA), tridodecylamine, tributylphosphine oxide, tributylphosphine, trioctylphosphine oxide (TOPO), trioctylphosphine (TOP), ZnF₂, ZnCl₂, ZnBr₂, ZnI₂, GaF₃, GaCl₃, GaBr₃, GaI₃, AlF₃, AlCl₃, AlBr₃ or AlI₃.

For example, the ligands 40 may be thiols such as 1-dodecanethiol (DDT). In addition to the DDT, the ligands 40 may be various alkyl thiols such as 1-octanethiol, hexadecanethiol and decanethiol. Additionally, the ligands 40 may be derived from a solvent used in the fabrication method. Here, the solvent may be at least one of 1-octadecene (ODE), oleylamine (OLA), oleic acid (OA), dodecylamine, trioctylamine (TOA), trioctylphosphine (TOP), 1-butanethiol, 1-hexanethiol, 1-octanethiol (OTT), 1-undecanethiol, decanethiol, 1-dodecanethiol (DDT), 1-hexadecanethiol, or 1-octadecanethiol.

The Group 17 element may be attached in an atomic or ionic form. For example, the Group 17 element is I. The Group 17 element may be F, Cl, Br.

The quantum dots 10 according to the present disclosure may be free of defect state by the Group 17 element 30. The quantum dots 10 include the Group 17 element 30, i.e., halogen on the surface, resulting in enhanced band-edge emission and reduced defect state emission. Accordingly, the quantum dots 10 may have narrow full width at half maximum. The known I-III-VI based quantum dots include various defects therein, and exhibit various emission through the defects. That is, defect state emission is dominated, and the emission spectrum is broad. It can be used in lighting applications. In contrast, the quantum dots 10 according to the present disclosure exhibit the emission spectrum in a desired color, for example, red, at the very narrow full width at half maximum due to the dominant band-edge emission, and thus can be used in display applications.

The Group 11 element in the quantum dot core 20 may be Ag. Group 13 element may be In or Ga, and Group 16 element may be S or Se. The quantum dot core 20 may include one Group 11 element, one or two Group 13 elements, and two Group 16 elements.

The composition of the quantum dot core 20 may be AgInₓGa₁₋ₓS_{y}Se_{1-y} (0.25≤x≤1.0, 0.5≤y<1).

In some embodiments, the quantum dot core 20 may include Ag. In, Ga, S and Se. In this case, the quantum dot core 20 may be referred to as AIGSSe core.

In some embodiments, the quantum dot core 20 may include Ag. In, S and Se. In this case, the quantum dot core 20 may be referred to as AISSe core. When the quantum dot core 20 includes only In as the Group 13 element, x is 1 in the composition AgInₓGa₁₋ₓS_{y}Se_{1-y}, so the composition may be referred to as AgInS_{y}Se_{1-y} (0.5≤y<1).

The emission wavelength of the quantum dot core 20 may be adjusted from the red region (590 nm) to the infrared region (700 nm or more) by adjusting the diameter and composition of the quantum dot core 20. For example, as the diameter of the quantum dot core 20 is larger, the emission wavelength may be longer. As x in the composition is larger, that is, as the amount of In is larger, the emission wavelength may be longer. As x is smaller, that is, as the amount of Ga is larger, the emission wavelength may be shorter. As y is smaller, that is, as the amount of Se is larger, the emission wavelength may be longer. As y is larger, that is, as the amount of S is larger, the emission wavelength may be shorter.

When the quantum dot core 20 includes In and Ga, In:Ga may be 2:8 to 1:0. Accordingly, Ga/In in the quantum dot core 20 may be 0 to 4. Within the above-described ratio, the quantum dot core 20 may emit light in a variety of desired wavelength bands and may change the band-edge emission peak wavelength. In particular, it may be possible to realize various wavelength bands in the red region according to In:Ga. As the amount of In is larger, the emission wavelength may be longer. As the amount of Ga is larger, the emission wavelength may be shorter. When In:Ga is smaller than 2:8, it is difficult to realize a desired wavelength band.

The quantum dot core 20 may have Se:S of 1:100 to 1:1. Accordingly, the quantum dot core 20 may have Se/S of 0.01 to 1.0. Within the above-described ratio, the quantum dot core 20 may emit light in various wavelength bands, and may change the band-edge emission peak wavelength. For example, when In:Ga in the quantum dot core 20 is 5:5 and Se/S in the quantum dot core 20 changes, the band-edge emission peak wavelength may change from 590 nm to infrared region. That is, it may be possible to emit not only visible light but also infrared region by adjusting Se/S. Se may reduce the band gap of the quantum dot core including Ag. In, Ga and S, thereby adjusting the emission wavelength. When In:Ga is larger than 5:5, it is possible to realize red emission even in a smaller amount of Se. However, when In:Ga is smaller than 5:5, a larger amount of Se is needed for red emission. However, when the amount of Se increases, the full width at half maximum increases, so it is necessary to adequately control the amount of Se. The quantum dot core that does not include Se and includes Ag. In, Ga and S does not emit red light at In:Ga in a range between 2:8 to 1:0, and for red emission, the quantum dot core essentially includes Se. Additionally, since the quantum dot core including Ag. In and S, but not Se, does not emit red light, the quantum dot core essentially includes Se for red emission.

When Se/S is smaller than 0.01, the wavelength adjustment effect through the addition of Se is insignificant. For example, it is difficult to realize red emission. As the amount of Se is larger, the emission wavelength may be longer. As the amount of S is larger, the emission wavelength may be shorter. In particular, the amount of Se affects the full width at half maximum. When Se/S is larger than 1, the full width at half maximum is 100 nm or more, which makes it difficult to use as red emitting display materials. The diameter of the quantum dot core 20 may change depending on the reaction temperature for synthesis, and as the reaction temperature increases, the diameter may increase. For example, the reaction temperature may be 180° C. to 300° C. although it may change depending on the type of the precursor.

For example, when Ga precursor is used to form AIGSSe core, the reaction temperature may be 240° C. to 300° C. The quantum dot core 20 synthesized at the above-described reaction temperature may be 5 nm to 8 nm in diameter. For example, when Ga precursor is not used when forming AISSe core, the reaction temperature may be 180° C. to 220° C. The quantum dot core 20 synthesized at the above-described reaction temperature may be 3.5 nm to 6.5 nm in diameter.

The diameter of the quantum dot core 20 may be 3.5 nm to 8 nm. When the diameter of the quantum dot core 20 is outside of the above-described range, it is not desirable in terms of photoluminescent quantum yield. Since the fabrication method according to the present disclosure synthesizes the quantum dot core 20 in a short time, it is proper to fabricate the quantum dot core 20 in the above-described diameter.

For example, when In:Ga in the quantum dot core 20 is 5:5 and the diameter of the quantum dot core 20 changes, the band-edge emission peak wavelength may change from 600 nm to 650 nm. That is, it may be possible to emit the red region and change the emission peak wavelength depending on the diameter of the quantum dot core 20. The quantum dots 10 including the quantum dot core 20 may be used as display materials.

The quantum dots 10 may have a ratio of band-edge emission intensity and defect state emission intensity of 2:1 or less on the full PL spectrum of the quantum dot core 20. That is, the band-edge emission may be dominant. Accordingly, the full width at half maximum may be narrower. Under 450 nm blue light excitation, the quantum dot core 20 may exhibit the molar absorption coefficient of 1.8×10⁶ M⁻¹ cm⁻¹ or more. As described above, the quantum dots 10 including the quantum dot core 20 may be red quantum dots with high blue absorbance. In particular, the quantum dots 10 may be fabricated as visible light emitting quantum dots with higher absorbance than red InP quantum dots. As described above, according to the present disclosure, it may be possible to form the quantum dot core 20 exhibiting a remarkably low level of defect state emission, especially AIGSSe core or AISSe core.

Referring to (b) of FIG. 1, the quantum dots 10 according to an embodiment of the present disclosure may further include the shell 50 on the quantum dot core 20, the shell 50 including at least one of Group 12 elements or Group 13 elements and at least one of Group 16 elements. As described above, according to the present disclosure, it may be possible to form the quantum dot core 20 exhibiting a remarkably low level of defect state emission, and synthesize the quantum dots 10 having high color purity after the core/shell step.

In this instance, the shell 50 may be a two or more component system composition including at least one including at least Ga among Al, Ga or In and at least one including at least S among S and Se. For example, the shell 50 may include Ga and S. The Ga precursor for forming the shell 50 may be GaCl₃, and Zn precursor may be ZnCl₂.

The shell 50 may be a multicomponent single or multi shell structure. The multi shell may be double or triple. When the shell 50 is a double or triple or multi shell, the shell 50 may have a gradual increase in band gap in the outward direction, i.e., as it is farther away from the quantum dot core 20. The shell 50 has high passivation effect. Accordingly, the PL and photoluminescent quantum yield of the quantum dots 10 may be improved.

Due to the shell 50, the defect states of the quantum dot core 20 may be further removed. Due to further including the shell 50, the band-edge emission area ratio may increase compared to the quantum dot core 20.

As described above, the diameter of the quantum dot core 20 may be 3.5 nm to 8 nm. The shell 50 may be formed with the thickness of 1 nm to 3 nm on the quantum dot core 20. In some embodiments, the diameter of the quantum dots 10 including the shell 50 may be 4.5 nm to 11 nm.

The emission intensity of the quantum dots 10 further including the shell 50 may be at least 4 times higher than the quantum dot core 20. The photoluminescent quantum yield of the quantum dots 10 including the shell 50 may be 65% or more in the visible light region (400 nm to 700 nm). The photoluminescent quantum yield of the quantum dots 10 including the shell 50 may be 30% or more in the infrared region (700 nm or more). The photoluminescent quantum yield of the quantum dots 10 is a minimum of 30%, and the photoluminescent quantum yield of the quantum dots 10 may be further increased through band gap engineering of the shell 50. The full width at half maximum of the quantum dots 10 including the shell 50 may be 55 nm or less in the visible light region. The full width at half maximum of the quantum dots 10 including the shell 50 may be 100 nm or less in the infrared region.

Under 450 nm blue light excitation, the quantum dots 10 including the shell 50 may exhibit the molar absorption coefficient of 7.1×10⁵ M⁻¹ cm⁻¹ or more.

According to the present disclosure, the inclusion of the AIGSSe or AISSe quantum dot core 20 may increase the photoluminescent quantum yield of the I-III-VI based quantum dots 10, and fabricate the surface controlled quantum dots 10 for defect state emission. The high efficiency quantum dots 10 fabricated according to the present disclosure may be synthesized as visible light emitting quantum dots with higher absorbance than InP quantum dots. It may be possible to obtain the quantum dots 10 that can emit from the red region (590 nm) to the infrared region (700 nm or more) by adjusting Ga/In and Se/S in the quantum dot core 20. The quantum dots 10 synthesized using the halide based metal salt precursor according to the present disclosure may be fabricated as quantum dots including Group 17 element 30 on the surface, with enhanced band-edge emission and suppressed defect state emission. According to the present disclosure, it may be possible to form the multicomponent quantum dot core 20 including four or more elements selected from a combination of Group 11-Group 13-Group 16 exhibiting a remarkably low level of defect state emission, and fabricate the quantum dots 10 with high color purity after the core/shell step. The quantum dots 10 according to the present disclosure may be red quantum dots with high blue absorbance. The quantum dots 10 according to the present disclosure may be used as display materials due to dominant band-edge emission.

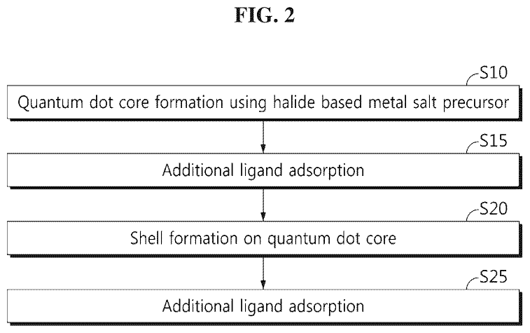

FIG. 2 is a flowchart of a method for fabricating quantum dots according to an embodiment of the present disclosure.

For example, a method for synthesizing the AIGSSe or AISSe quantum dot core will be described. To synthesize the quantum dot core, the halide based metal salt precursor is used (step S10).

As described with reference to FIG. 1, the Group 17 element 30 of the quantum dots 10 is supplied from the halide based metal salt precursor. The halide based metal salt precursor may include a Group 11 precursor and a Group 13 precursor, and the Group 17 element 30 may be supplied from the Group 11 precursor and the Group 13 precursor.

In this instance, the Group 11 precursor and the Group 13 precursor may be at least one of AuF, AuCl, AuBr, AuI, CuF, CuCl, CuBr, CuI, AgF, AgCl, AgBr, AgI, InF₃, InCl₃, InBr₃, InI₃, GaF₃, GaCl₃, GaBr₃ or GaI₃.

The halide based metal salt precursor may include the Group 11 precursor and the Group 13 precursor, and the Group 11 element and the Group 13 element of the halide based metal salt precursor may be synthesized into the precursor in powder state or as it is dissolved in a solvent.

The halide based metal salt precursor may further include a Group 16 precursor, and the Group 16 element of the Group 16 precursor may be fed as it is dissolved in a solvent.

The solvent may be at least one of 1-octadecene (ODE), oleylamine (OLA), oleic acid (OA), dodecylamine, trioctylamine (TOA), trioctylphosphine (TOP), 1-butanethiol, 1-hexanethiol, 1-octanethiol (OTT), 1-undecanethiol, decanethiol, 1-dodecanethiol (DDT), 1-hexadecanethiol, or 1-octadecanethiol.

In a preferred example, the AIGSSe quantum dot core 20 may be synthesized by mixing the Ag precursor, I precursor, Ga precursor, S precursor and Se precursor with the solvent to prepare a mixed solution and heating the mixed solution. The heating of the mixed solution may be performed by multiple steps. First, degassing may be performed by heating at 120° C. Subsequently, the temperature may rise to the growth temperature. In this instance, N₂ purging may be performed.

For example, the halide based metal salt precursor, AgI, InI₃, GaI₃, which is the precursor of the AIGSSe quantum dot core 20 and the solvent are put into a 3-neck flask and degassing is performed at the temperature of 120° C. or less for 30 minutes or longer, followed by N₂ substitution. Here, the solvent may be ODE, OLA, OA, etc.

Subsequently, the thiol based ligand such as OTT and the Group 16 precursor such as the S precursor and the Se precursor are fed, and after the temperature rises to 240° C. or more, the quantum dot core synthesis reaction is completed within 10 minutes. The reaction temperature at the step of synthesizing the quantum dot core 20 may be 240° C. to 300° C. In addition to the OTT, alkyl thiols such as DDT, hexadecanethiol and decanethiol may be used. The S precursor may contain S dissolved in OLA, and the Se precursor may contain Se dissolved in OLA or OTT. Here, the OLA or OLA is a solvent, and a variety of fatty amines such as dodecylamine, trioctylamine, trioctylphosphine may be used.

In another preferred example, the AISSe quantum dot core 20 may be synthesized by heating the mixed solution prepared by mixing the Ag precursor, I precursor, S precursor and Se precursor with the solvent. Here, the heating of the mixed solution may be performed by multiple steps. First, degassing may be performed by heating at 120° C. Subsequently, the temperature may rise to the growth temperature. In this instance, N₂ purging may be performed.

For example, the halide based metal salt precursor, AgI, InI₃, which is the precursor of the AISSe quantum dot core 20 and the solvent are put into a 3 neck flask, and degassing is performed at the temperature of 120° C. or less for 30 minutes or longer, followed by N₂ substitution. Here, the solvent may be ODE, OLA, OA, etc.

Subsequently, the thiol based ligand such as OTT and the Group 16 precursor such as S precursor, Se precursor are fed, and after the temperature rises to 180° C. or more, the quantum dot core synthesis reaction is completed within 10 minutes. The reaction temperature at the step of synthesizing the quantum dot core 20 may be 180° C. to 220° C. In addition to the OTT, a variety of alkylthiols such as DDT, hexadecanethiol and decanethiol may be used. The S precursor may contain S dissolved in OLA, and the Se precursor may contain Se dissolved in OLA or OTT. Here, OLA or OLA is a solvent, and a variety of fatty amines such as dodecylamine, trioctylamine and trioctylphosphine may be used.

After synthesizing the quantum dot core 20, the method may further include the step of reducing the temperature down to 200° C. or less and feeding an additional ligand material such as trioctylphosphine (TOP) to protect the quantum dot core surface (step S15). This step is performed to remove defects that may exist on the surface of the quantum dot core 20. In addition to the TOP, tributylphosphine oxide, tributylphosphine and trioctylphosphine oxide (TOPO) may be used. This step is performed to improve the efficiency and stability of the quantum dot core 20 through additional ligand adsorption.

According to this method, it may be possible to synthesize the quantum dots 10 as shown in (a) of FIG. 1, and since the reaction is completed within 10 minutes, it may be possible to synthesize in a shorter time than the existing reported reaction time of 30 minutes or more and eliminate a complicated process such as additional feed, thereby achieving high reproducibility.

Subsequently, referring further to FIG. 2, the formed quantum dot core 20 is purified after precipitation using a polar solvent, to remove by-products and unreacted products except the quantum dot core 20. The polar solvent may be ethanol, acetone, methanol, acetonitrile, isopropanol, dimethylformamide, dimethylsulfoxide, etc. The purification may be performed using a hexane/ethanol combined solvent using a centrifugal separator (9000 rpm, 10 min), followed by re-dispersion in a non-polar solvent to form the shell 50 (step S20). Here, the non-polar solvent may be hexane, octane, toluene, chloroform, ODE, OLA, etc.

The step of forming the shell 50 is the step of forming the shell 50 on the quantum dot core 20, the shell 50 including at least one of Group 12 elements or Group 13 elements and at least one of Group 16 elements.

For example, when forming GaS (shortened to GS) shell, the Ga precursor and the S precursor may be fed, causing reaction at the temperature of 200° C. or more, for example, 240° C. for 1 hour, and after the temperature rises to 250° C. or more, the reaction is completed within 10 minutes. After the temperature is lowered to 200° C. or less, the additional ligand material such as TOP, OTT may be fed to protect the surface of the core/shell quantum dots (step S25). The Ga precursor may be GaCl₃, and the S precursor may be sulfur.

The shell may be formed using any other composition than GaS, and may be formed by applying a suitable shell stock solution onto the core. Additionally, the step of forming the shell may be performed consecutively two or more times. In this instance, at least one of the type, concentration or reaction temperature of the shell stock solution and the time may be different for each step. In the second reaction, the temperature may be higher or the time may be longer. According to this method, the quantum dots 10 including the shell 50 as shown in (b) of FIG. 1 may be fabricated.

According to the present disclosure, to increase the photoluminescent quantum yield of the AIGSSe or AISSe quantum dots and reduce the defect state emission, the surface controlled quantum dots may be fabricated. The high efficiency quantum dots fabricated according to the present disclosure may be synthesized as visible light emitting quantum dots with higher absorbance than InP quantum dots. According to the present disclosure, red quantum dots with high blue absorbance may be synthesized. Compared to quantum dots synthesized using acetate or acetylacetonate based (i.e., non-halide based) metal salt precursors, the quantum dots synthesized using the halide metal salt precursor according to the present disclosure include halogen on the surface, and thus may be synthesized as quantum dots with enhanced band-edge emission and reduced defect state emission. According to the present disclosure, it may be possible to form AIGSSe or AISSe core exhibiting a remarkably low level of defect state emission, and synthesize quantum dots having high color purity after the core/shell step. According to the present disclosure, it may be possible to reduce the synthesis time compared to the existing method.

The step S25 is the step of feeding the ligand material to protect the surface of the quantum dots 10 after the step of forming the shell 50. The additional ligand material such as TOP, OTT or DDT may be fed to remove defects that may exist on the surface of the quantum dots 10, thereby further improving the efficiency and stability of the quantum dots 10.

Hereinafter, the present disclosure will be described in more detail by describing experimental examples.

### Characteristics Evaluation

The absorption and emission characteristics are evaluated in colloidal state by dispersing in the non-polar solvent such as hexane, toluene, chloroform after the precipitation of the synthesized quantum dot core and core/shell quantum dots in the polar solvent such as ethanol, acetone.

### Evaluation Tool

To analyze the emission characteristics of the synthesized nanocrystals (quantum dot core and core/shell quantum dots), the nanocrystals were dispersed in hexane, and PL was measured at room temperature using PL equipment (Edinburgh instruments FS5) using 500 W Xenon arc lamp as a light source. For the photoluminescent quantum yield, Absolute PL QY (Otsuka QE 2000) was used. To analyze the size and shape of the dispersed nanocrystals, high resolution transmittance electron microscopy (HRTEM) (JEOL JEM F200) was used.

### Experimental Example 1: AIGSSe/GS Quantum Dots as a Function of Core Synthesis Temperature

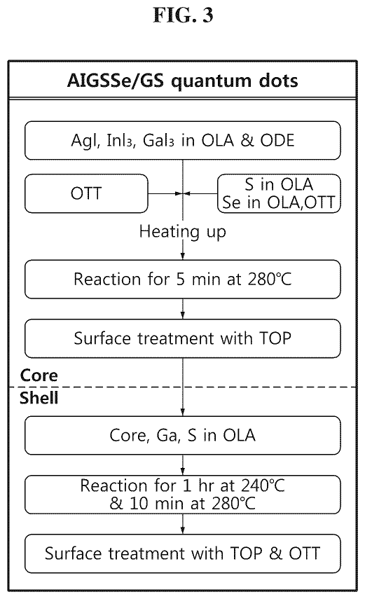

FIG. 3 is a flowchart of a method for fabricating AIGSSe/GS core/shell quantum dots according to experimental example of the present disclosure.

To synthesize AIGSSe quantum dot core, AgI, InI₃, GaI₃ and OLA, ODE were put into a 3 neck flask, and degassing was performed at 120° C. for 30 minutes, followed by N₂ substitution. In this instance, In:Ga was 5:5.

S mixed with OTT and OLA and Se mixed with OLA and OTT were fed into the 3 neck flask, followed by heating up the temperature to 240° C. or more, causing reaction for 5 minutes. Three temperature conditions of 260° C., 280° C. and 300° C. were used, and typically, 280° C. is shown in FIG. 3.

Subsequently, after reducing the temperature down to 200° C. or less, for example, 180° C., the additional ligand material, TOP, was added to cause reaction for 20 minutes to protect the quantum dot core surface (surface treatment). The quantum dot core synthesis was completed. The steps until “Core” In the drawing were performed.

The quantum dot core was purified using the polar solvent, and the quantum dot core was re-dispersed in the nonpolar solvent to form GaS shell. The quantum dot core, GaCl₃ as the Ga source and S mixed with OLA were put into the 3 neck flask, causing reaction at the temperature of 200° C. or more, for example, 240° C. for 1 hour, followed by heating up the temperature to 250° C. or more, for example, 280° C., causing reaction for 10 minutes to form GaS shell. The thiol and metal salt-TOP mixture or TOP was fed at 200° C., causing reaction for 20 minutes to protect the surface of the core/shell quantum dots. In the experimental example, TOP and OTT were used. As described above, shelling is completed (the steps indicated by “Shell” in the drawing are performed), and AIGSSe/GS quantum dots are fabricated.

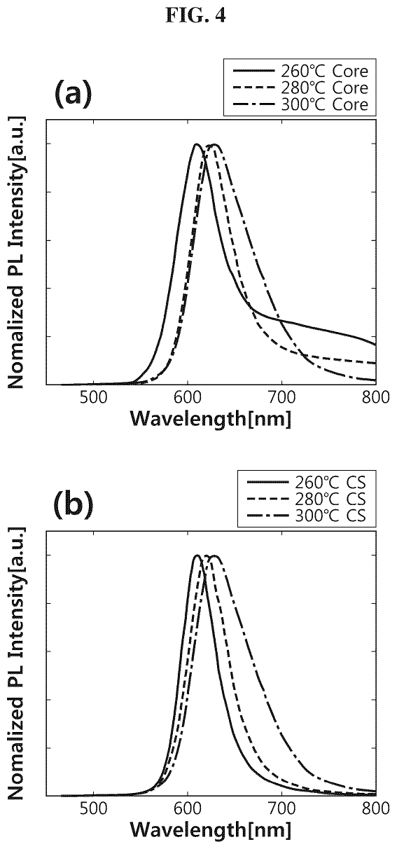

Subsequently, the core/shell quantum dots were purified using the polar solvent at room temperature and used for experiment and analysis. FIG. 4 shows (a) core and (b) core/shell emission spectrum of AIGSSe/GS quantum dots synthesized at various reaction temperatures (260° C., 280° C., 300° C.).

Referring to FIG. 4, it shows the emission spectrum as a function of core synthesis temperature using the halide based precursor. It can be seen that the emission wavelength is red-shifted from about 610 nm to 630 nm as the synthesis temperature increases. It can be seen that the higher synthesis temperature, the larger diameter of the quantum dot core.

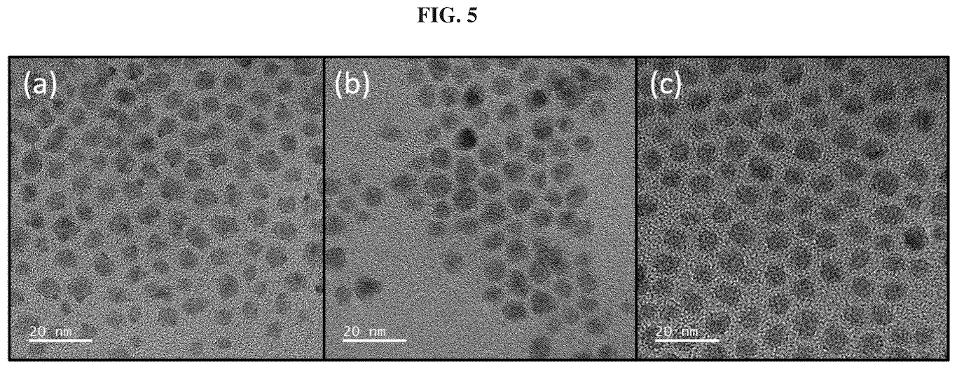

The diameter change of the quantum dot core as a function of core synthesis temperature can be seen through a transmission electron microscopy (TEM) image as shown in FIG. 5. FIG. 5 is a TEM image of the AIGSSe quantum dot cores synthesized at various reaction temperatures. (a) of FIG. 5 is a TEM image when the core synthesis temperature is 260° C., (b) of FIG. 5 is a TEM image when the core synthesis temperature is 280° C., and (c) of FIG. 5 is a TEM image when the core synthesis temperature is 300° C.

Referring to FIG. 5, as the core synthesis temperature increases to 260° C., 280° C., 300° C., the diameter of the quantum dot core increases from 5.5±0.5 nm to 7.5±0.5 nm, and it can be seen that these results are consistent with the red-shifted emission wavelength shown in FIG. 4. The diameter of the quantum dot core is not limited to the above-described size, and the quantum dot core may be synthesized with varying diameters of 5 nm to 8 nm or more on average according to the reaction temperature at the synthesis step and may be also synthesized with the emission wavelength of 630 nm or more. Table 1 shows the emission characteristics of the synthesized AIGSSe core and AIGSSe/GS core/shell.

TABLE 1

| | Major | | Quantum |
|---|---|---|---|
| | peak | Full width at half | yield |
| | (nm) | maximum (nm) | (%) |
| Core synthesized at reaction | 611 | 59 | 10 |
| temperature of 260° C. | | | |
| Core synthesized at reaction | 621 | 52 | 12 |
| temperature of 280° C. | | | |
| Core synthesized at reaction | 628 | 70 | 16 |
| temperature of 300° C. | | | |
| Core/shell synthesized at | 611 | 44 | 73 |
| reaction temperature of 260° C. | | | |
| Core/shell synthesized at | 621 | 49 | 74 |
| reaction temperature of 280° C. | | | |
| Core/shell synthesized at | 628 | 68 | 58 |
| reaction temperature of 300° C. | | | |

Referring to Table 1, it can be seen that GaS shelling on the AIGSSe core leads to less defects, narrower full width at half maximum and higher efficiency.

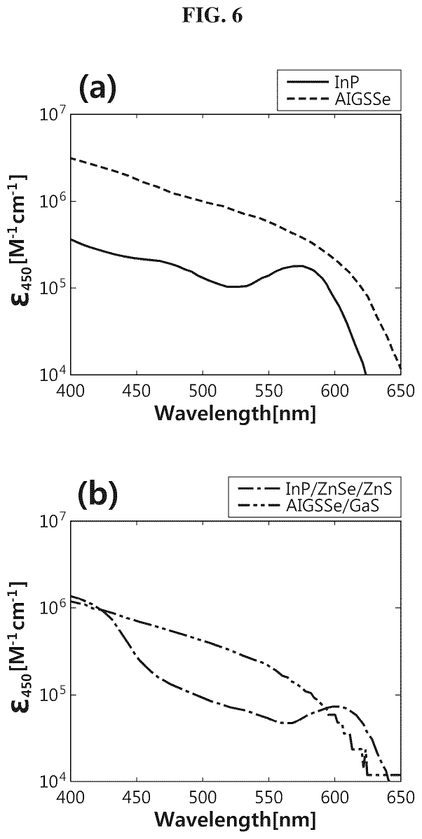

FIG. 6 shows (a) core and (b) core/shell absorbance spectrum of InP quantum dots according to comparative example and AIGSSe/GS quantum dots according to experimental example of the present disclosure.

With further research to address the low absorbance of green InP quantum dots, as a result of comparing the molar absorption coefficient (ε) of InP quantum dots and AIGSSe quantum dots synthesized using the halide based precursor under blue light (450 nm) excitation, it was confirmed that the absorption coefficient of the AIGSSe quantum dots (i.e., 1.8×10⁶ M⁻¹ cm⁻¹) was at least about 8 times higher than that of the InP quantum dots (i.e., 2.2×10⁵ M⁻¹ cm⁻¹). Here, the absorption coefficient was calculated by the Beer-Lambert law [molar absorption coefficient (a measure of the amount of light 1 M quantum dots can absorb)].

### Experimental Example 2: AIGSSe/GaS Quantum Dots as a Function of In/Ga in Core

AIGSSe/GaS core/shell quantum dots were fabricated by the same method as the method shown in FIG. 3.

In this instance, In:Ga in each core was different. In the experiment, In:Ga was 6:4, 5:5, 4:6. Se was fixed to 0.095 mmol, S was fixed to 1.3 mmol, and Se/S was fixed to 0.073.

The reaction temperature for core synthesis was 280° C. The remaining conditions were the same as those of experimental example 1.

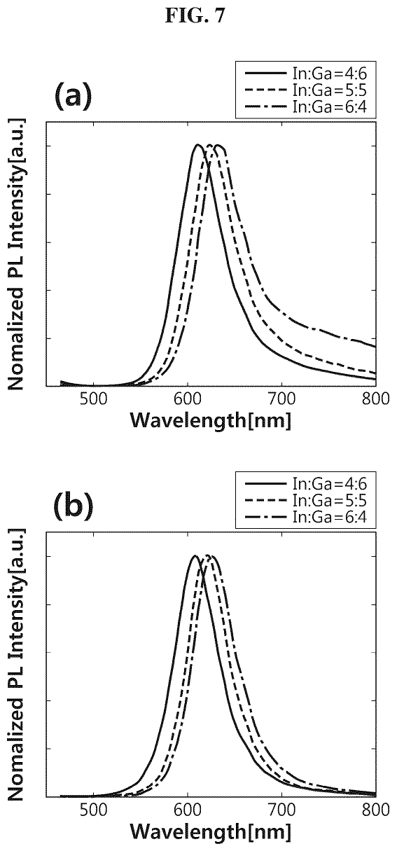

FIG. 7 shows (a) core and (b) core/shell emission spectrum of AIGSSe quantum dots synthesized with fixed Se/S and varying In:Ga.

FIG. 7 shows the emission spectrum as a function of the ratio of In and Ga in the core using the halide based precursor. With increasing In, there is a redshift.

Additionally, Table 2 shows the emission characteristics of synthesized AIGSSe core and AIGSSe/GaS core/shell.

TABLE 2

| | Major | | Quantum |
|---|---|---|---|
| | peak | Full width at half | yield |
| | (nm) | maximum (nm) | (%) |
| In:Ga = 4:6 core | 611 | 59 | 14 |
| In:Ga = 5:5 core | 621 | 52 | 12 |
| In:Ga = 6:4 core | 631 | 61 | 16 |
| In:Ga = 4:6 core/shell | 608 | 53 | 82 |
| In:Ga = 5:5 core/shell | 621 | 49 | 74 |
| In:Ga = 6:4 core/shell | 626 | 53 | 66 |

Referring to Table 2, it can be seen that as the amount of In increases with increasing In:Ga in the core from 4:6 to 6:4, the emission wavelength becomes longer from about 610 nm to about 630 nm. It can be seen that as the amount of In in In:Ga increases, the emission wavelength may be longer. All the emission wavelengths are in the red region. The wavelength is not limited thereto, and the emission wavelength of 630 nm or more may be synthesized by changing In:Ga.

Additionally, it can be seen that GaS shelling on the AIGSSe core leads less defects, narrower full width at half maximum and higher efficiency.

### Experimental Example 3: AIGSSe/GS Quantum Dots as a Function of Se/S in Core

The AIGSSe/GS core/shell quantum dots were fabricated by the same method as the method shown in FIG. 3.

In this instance, Se/S in each core was different. Se/S was 0 to 0.4. When Se/S is 0, it represents that Se was not fed, and it corresponds to comparative example. In the example, Se/S was 0.04, 0.12, 0.2, 0.4.

The reaction temperature for core synthesis was 280° C. The remaining conditions were the same as those of experimental example 1.

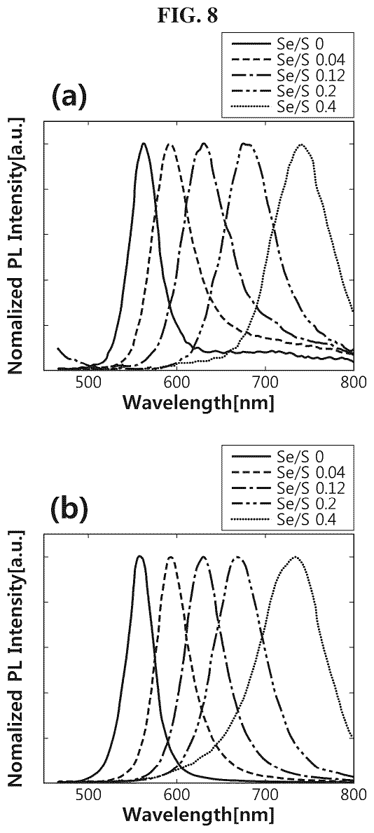

FIG. 8 shows (a) core and (b) core/shell emission spectrum of AIGSSe quantum dots synthesized with varying Se/S.

FIG. 8 shows the emission spectrum as a function of the ratio of S and Se in the core using the halide based precursor. With increasing Se, there is a redshift.

Table 3 shows the emission characteristics of the synthesized AIGSSe core and AIGSSe/GS core/shell.

TABLE 3

| | Major | | Quantum |
|---|---|---|---|
| | peak | Full width at half | yield |
| Se/S molar ratio | (nm) | maximum (nm) | (%) |
| Se/S 0 core (comparative | 563 | 37 | 11 |
| example) | | | |
| Se/S 0.04 core | 593 | 53 | 14 |
| Se/S 0.12 core | 631 | 65 | 12 |
| Se/S 0.2 core | 676 | 69 | 19 |
| Se/S 0.4 core | 741 | 77 | 13 |
| Se/S 0 core/shell (comparative | 558 | 36 | 84 |
| example) | | | |
| Se/S 0.04 core/shell | 593 | 44 | 74 |
| Se/S 0.12 core/shell | 630 | 52 | 40 |
| Se/S 0.2 core/shell | 668 | 67 | 56 |
| Se/S 0.4 core/shell | 734 | 87 | 40 |

Referring to Table 3, comparative example without Se does not emit red light. It can be seen that as Se/S in core changes to 0.05 to 0.4, that is, as the amount of Se increases, the emission wavelength may become longer from about 590 nm to about 745 nm. The Se/S and emission wavelength are not limited thereto and quantum dots with Se/S of 0.4 or more and quantum dots with the emission wavelength of 750 nm or more may be synthesized. It can be also seen that as the amount of Se is smaller, quantum dots with narrower full width at half maximum may be synthesized.

Additionally, it can be seen that quantum dots having the ability to emit the infrared region may be obtained by increasing the amount of Se to increase the emission wavelength. It can be seen that GaS shelling on the AIGSSe core leads to less defects, narrower full width at half maximum and higher efficiency.

### Experimental Example 4: AISSe/GS Quantum Dots as a Function of Core Synthesis Temperature

AISSe/GS quantum dots were fabricated by the method for fabricating quantum dots of experimental example 1 as shown in FIG. 3. However, the type of the precursor and the reaction temperature for synthesis of the AISSe quantum dot core are different from experimental example 1.

To synthesize the AISSe quantum dot core, AgI, InI₃ and OLA, ODE were put into a 3 neck flask, and degassing was performed at 120° C. for 30 minutes, followed by N₂ substitution.

S mixed with OTT and OLA and Se mixed with OLA and OTT were fed into the 3 neck flask, followed by heating up the temperature to 140° C. or more, causing reaction for 5 minutes. Three temperature conditions of 180° C., 200° C. and 220° C. were used.

The subsequent step may be performed in the same way as experimental example 1 to form GaS shell to fabricate quantum dots. Subsequently, the core/shell quantum dots were purified using the polar solvent at room temperature and used for experiment and analysis.

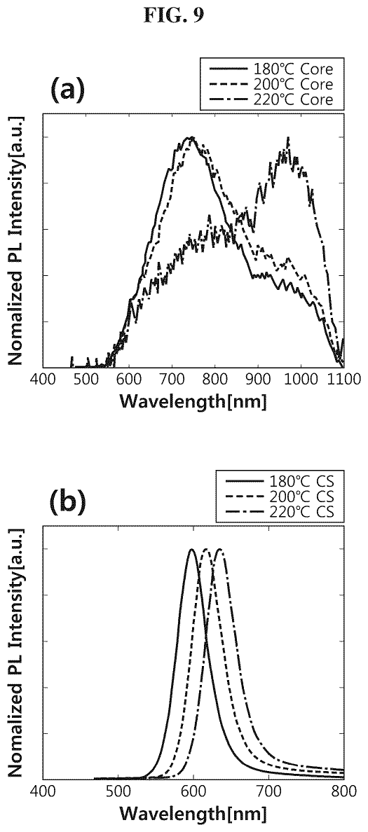

FIG. 9 shows (a) core and (b) core/shell emission spectrum of AISSe/GS quantum dots synthesized at various reaction temperatures (180° C., 200° C., 220° C.). Se/S in the core was fixed to 0.15.

Referring to FIG. 9, it shows the emission spectrum as a function of core synthesis temperature using the halide based precursor. It can be seen that as the synthesis temperature increases, the emission wavelength is red-shifted from about 595 nm to 635 nm. It can be seen that as the synthesis temperature increases, the diameter of the quantum dot core increases.

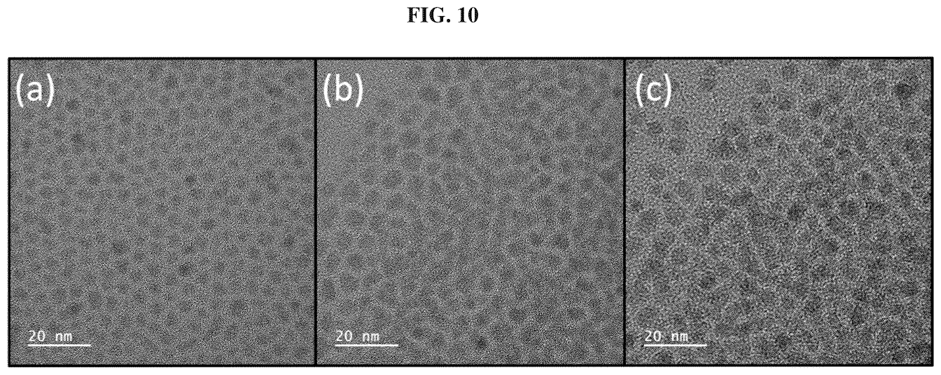

The diameter change of the quantum dot core as a function of core synthesis temperature can be seen through a TEM image as shown in FIG. 10. FIG. 10 is a TEM image of AISSe quantum dot core synthesized at various reaction temperatures. (a) of FIG. 10 is a TEM image when the core synthesis temperature is 180° C., (b) of FIG. 10 is a TEM image when the core synthesis temperature is 200° C., and (c) of FIG. 10 is a TEM image when the core synthesis temperature is 220° C.

Referring to FIG. 10, as the core synthesis temperature increases to 180° C., 200° C. and 220° C., the diameter of the quantum dot core increases from 4±0.5 nm to 6±0.5 nm, and it can be seen that these results are consistent with the red-shifted emission wavelength shown in FIG. 9. The diameter of the quantum dot core is not limited to the above-described size and the quantum dot core may be synthesized with varying diameters of 3.5 nm to 6.5 nm or more on average according to the reaction temperature at the synthesis step and may be also synthesized with the emission wavelength of 650 nm or more.

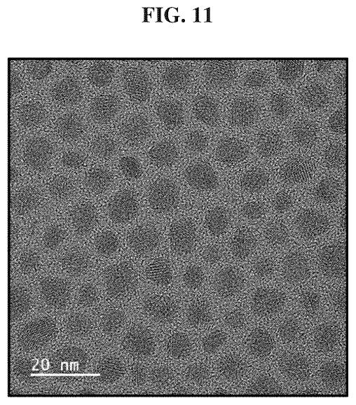

FIG. 11 is a TEM image of AISSe/GS quantum dots including GaS shell on AISSe quantum dot core synthesized in a specific condition (200° C., Se/S 0.15).

Referring to FIG. 11, it can be seen that when a shell is formed on the core synthesized in the specific condition, the shell may be 2 nm or more, and the core/shell quantum dots may be synthesized with the diameter of 7.5 nm to 9.5 nm or more on average.

Table 4 shows the emission characteristics of the synthesized AISSe/GS core/shell.

TABLE 4

| | Major | | Quantum |
|---|---|---|---|
| | peak | Full width at half | yield |
| | (nm) | maximum (nm) | (%) |
| Core/shell synthesized at | 596 | 54 | 66 |
| reaction temperature of 180° C. | | | |
| Core/shell synthesized at | 615 | 48 | 70 |
| reaction temperature of 200° C. | | | |
| Core/shell synthesized at | 632 | 50 | 65 |
| reaction temperature of 220° C. | | | |

Referring to Table 4, it can be seen that GaS shelling on the AISSe core leads to band-edge emission, narrower full width at half maximum and higher efficiency.

### Experimental Example 5: AISSe/GS Quantum Dots as a Function of Se/S in Core

AISSe/GS core/shell quantum dots were fabricated by the same method as experimental example 4.

In this instance, Se/S in each core was different. Se/S was 0 to 0.38. When Se/S is 0, it represents that Se was not fed (AIS/GS), and it corresponds to comparative example. In the example, Se/S was 0.08, 0.15, 0.23, 0.31, 0.38.

The reaction temperature for core synthesis was 200° C. The remaining conditions were the same as those of experimental example 4.

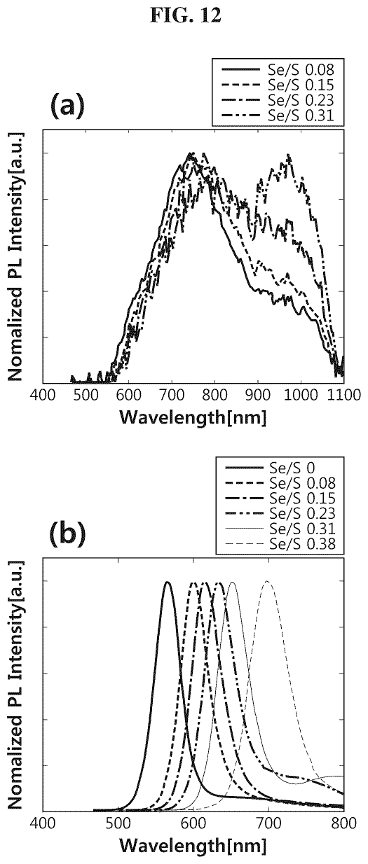

FIG. 12 shows (a) core and (b) core/shell emission spectrum of AISSe quantum dots synthesized with varying Se/S.

FIG. 12 shows the emission spectrum as a function of the ratio of S and Se in the core using the halide based precursor. With increasing Se, there is a redshift.

Table 5 shows the emission characteristics of the synthesized AISSe core and AISSe/GS core/shell.

TABLE 5

| | Major | | Quantum |
|---|---|---|---|
| | peak | Full width at half | yield |
| Se/S molar ratio | (nm) | maximum (nm) | (%) |
| Se/S 0 core/shell | 565 | 41 | 60 |
| Se/S 0.08 core/shell | 600 | 44 | 76 |
| Se/S 0.15 core/shell | 615 | 48 | 70 |
| Se/S 0.23 core/shell | 631 | 49 | 30 |
| Se/S 0.31 core/shell | 651 | 48 | 30 |
| Se/S 0.38 core/shell | 700 | 60 | — |

Referring to Table 5, comparative example without Se does not emit red light. It can be seen that as Se/S in the core changes to 0.08 to 0.38, that is, as the amount of Se increases, the emission wavelength becomes longer from about 600 nm to about 700 nm. The Se/S and emission wavelength is not limited thereto and quantum dots with Se/S of 0.38 or more and the emission wavelength of 700 nm or more may be synthesized. It can be seen that as the amount of Se is smaller, quantum dots with narrower full width at half maximum may be synthesized.

Additionally, it can be seen that quantum dots having the ability to emit the infrared region may be obtained by increasing the amount of Se to increase the emission wavelength. It can be seen that GaS shelling on the AISSe core removes defects, leading to narrower full width at half maximum and higher efficiency.

### SUMMARY OF EXPERIMENTAL RESULTS

As can be seen from FIGS. 4, 7 and 8, the full width at half maximum of the emission peak is narrow according to the present disclosure, and this represents that the emission characteristics of the core synthesized using the halide based precursor are usually band-edge emission. The diameter change of the quantum dot core according to the synthesis temperature can be seen from the TEM image of FIG. 5. Additionally, a wavelength change with a change in diameter of the quantum dot core, a wavelength change with a change in In:Ga in the core, and a wavelength change (590 nm to 700 nm or more) with a change in Se/S in the core can be seen from FIGS. 4, 7 and 8.

Additionally, it can be seen through Tables 1 to 3 that the core/shell structure including the Ga containing shell and the additional ligand material to protect the surface of the quantum dots has suppressed defect state emission and narrower full width at half maximum than the quantum dot core.

As can be seen from FIGS. 9 and 12, the full width at half maximum of the emission peak is narrow according to the present disclosure, and this represents that the emission characteristics of the core synthesized using the halide based precursor are defect state emission, and shelling suppresses defect state emission and enhances band-edge emission. The diameter change of the quantum dot core as a function of synthesis temperature can be seen from the TEM image of FIG. 10. Additionally, a wavelength change with a change in diameter of the quantum dot core and a wavelength change (590 nm˜700 nm or more) with a change in Se/S in the core can be seen from FIGS. 9 and 12.

Additionally, it can be seen through Tables 4 and 5 that the core/shell structure including the Ga containing shell and the additional ligand material to protect the surface of the quantum dots has suppressed defect state emission and narrow full width at half maximum.

For use of light emitting materials in display applications, materials having high color purity are required, and as the full width at half maximum is narrower, the color purity is higher. As the defect state emission intensity is higher, the full width at half maximum increases, resulting in lower color purity, which makes it difficult to use in industrial applications. The core-shell structured quantum dots synthesized using the halide precursor according to the present disclosure are suitable for use in the industrial applications due to the significantly low defect state emission.

This work was financially supported by the Technology Innovation Program (20010737, 20016332) funded by the Ministry of Trade, Industry & Energy (MOTIE, Korea), the National Research Foundation of Korea (NRF) grant funded by Ministry of Science, ICT & Future Planning (MSIP) (2020M3H4A3082656) and Basic Science Research Program through the NRF funded by Ministry of Education (2015R1A6A1A03031833).

While the present disclosure has been hereinabove illustrated and described with respect to exemplary embodiments, the present disclosure is not limited thereto and various modifications and changes will be made thereto by those skilled in the art without departing from the technical aspects of the present disclosure.

What is claimed is:

1. Quantum dots, comprising:
a multicomponent quantum dot core including four or more elements selected from a combination of Group 11-Group 13-Group 16,
the quantum dots configured to emit a band-edge peak wavelength from a red region (590 nm) to an infrared region (700 nm or more).

2. The quantum dots according to claim 1, further comprising:
Group 17 element attached to a surface of the multicomponent quantum dot core.

3. The quantum dots according to claim 1, wherein in the multicomponent quantum dot core, the Group 11 element comprises Ag, wherein the Group 13 element comprises In or Ga, and wherein the Group 16 element comprises S or Se.

4. The quantum dots according to claim 3, wherein the multicomponent quantum dot core includes In and Ga, and wherein the Ga/In in the quantum dot core is 0 to 4.

5. The quantum dots according to claim 3, wherein the multicomponent quantum dot core includes S and Se, and wherein the Se/S in the quantum dot core is 0.01 to 1.0.

6. The quantum dots according to claim 1, further comprising:
ligands on a surface of the multicomponent quantum dot core.

7. The quantum dots according to claim 6, wherein the ligands comprise at least one of thiols, amines, phosphines, or metal salts.

8. The quantum dots according to claim 2, wherein the multicomponent quantum dot core includes Ag, In, Ga, S and Se, or includes Ag, In, S and Se, and wherein the Group 17 element is I attached in an atomic or ionic form.

9. The quantum dots according to claim 1, further comprising:
a shell on the multicomponent quantum dot core, wherein the shell includes:
at least one of Group 12 element or Group 13 element; and
at least one of Group 16 elements.

10. The quantum dots according to claim 9, wherein the shell has a composition including:
at least one including at least Ga among Al, Ga and In, and at least one including at least S among S and Se.

11. The quantum dots according to claim 9, wherein the multicomponent quantum dot core is configured to exhibit defect state emission, and wherein the shell is configured to realize band-edge peak wavelength.

12. A method for fabricating quantum dots, comprising:
synthesizing a quantum dot core using a halide based metal salt precursor,
wherein the quantum dot core comprises a multicomponent quantum dot core including four or more elements selected from a combination of Group 11-Group 13-Group 16,
wherein the quantum dots include Group 17 element attached to a surface of the quantum dot core, and
wherein the Group 17 element is supplied from the halide based metal salt precursor.

13. The method for fabricating quantum dots according to claim 12, wherein the halide based metal salt precursor includes a Group 11 precursor and a Group 13 precursor, and wherein the Group 17 element is supplied from the Group 11 precursor and the Group 13 precursor.

14. The method for fabricating quantum dots according to claim 13, wherein the Group 11 precursor and the Group 13 precursor comprise at least one of AuF, AuCl, AuBr, AuI, CuF, CuCl, CuBr, CuI, AgF, AgCl, AgBr, AgI, InF₃, InCl₃, InBr₃, InI₃, GaF₃, GaCl₃, GaBr₃, or GaI₃.

15. The method for fabricating quantum dots according to claim 12, wherein in addition to the halide based metal salt precursor, a Group 16 precursor is further used, and Group 16 element of the Group 16 precursor is fed as it is dissolved in a solvent.

16. The method for fabricating quantum dots according to claim 15, wherein the solvent comprises at least one of 1-octadecene (ODE), oleylamine (OLA), oleic acid (OA), dodecylamine, trioctylamine (TOA), trioctylphosphine (TOP), 1-butanethiol, 1-hexanethiol, 1-octanethiol (OTT), 1-undecanethiol, decanethiol, 1-dodecanethiol (DDT), 1-hexadecanethiol, or 1-octadecanethiol.

17. The method for fabricating quantum dots according to claim 12, wherein a reaction temperature at the synthesis of the quantum dot core is 240° C. to 300° C.

18. The method for fabricating quantum dots according to claim 12, further comprising:
forming a shell on the quantum dot core, wherein the shell includes:
at least one of Group 12 element or Group 13 element; and
at least one of Group 16 elements.

19. The method for fabricating quantum dots according to claim 18, after synthesizing the quantum dot core or forming the shell, further comprising:
feeding a ligand material to protect the surface of the quantum dots.

20. The method for fabricating quantum dots according to claim 19, wherein the ligand comprises at least one of tributylphosphine oxide, tributylphosphine, trioctylphosphine oxide (TOPO), or trioctylphosphine (TOP).
